(19) United States
(12) Patent Application Publication
(10) Pub. No.: US 2020/0133322 A1
(43) Pub. Date: Apr. 30, 2020

(54) ASYMMETRIC PHASE CURRENT REGULATION FOR MULTIPHASE SWITCHMODE POWER SUPPLIES

(71) Applicant: Renesas Electronics America Inc., Milpitas, CA (US)

(72) Inventor: Steven Patrick LAUR, Raleigh, NC (US)

(21) Appl. No.: 16/661,795

(22) Filed: Oct. 23, 2019

Related U.S. Application Data
(60) Provisional application No. 62/750,039, filed on Oct. 24, 2018.

(51) Int. Cl. G05F 1/575; H02M 3/158

(52) U.S. Cl. CPC G05F 1/575; H02M 2003/1586; H02M 3/1584

(57) ABSTRACT

According to certain general aspects, the present embodiments relate generally to allowing phase currents of a multiphase switching power supply to be asymmetrically configured to any percentage of the total load current while maintaining excellent dynamic performance. According to certain other aspects, this allows for increased design flexibility for board area, solution cost and optimized efficiency.

### CROSS-REFERENCE TO RELATED APPLICATIONS

The present application claims priority to U.S. Provisional Patent Appin. No. 62/750,039 filed Oct. 24, 2018, the contents of which are incorporated herein by reference in their entirety.

### TECHNICAL FIELD

The present embodiments relate generally to power supplies, and more particularly to current regulation for multiphase switch-mode power supplies.

### BACKGROUND

DC-to-DC voltage conversion is often performed by switching voltage regulators, or step-down regulators—also referred to as voltage converters, point-of-load regulators, or power converters—converting an input voltage to a regulated output voltage as required by one or more load devices. More generally, voltage regulators and current regulators are commonly referred to as power converters, and as used herein, the term power converter is meant to encompass all such devices. Switching voltage regulators often use two or more power transistors to convert energy at one voltage to another voltage. Challenges in the design of voltage regulators, particularly in connection with operating under various load conditions, are many, creating an opportunity for many improvements.

### SUMMARY

According to certain general aspects, the present embodiments relate generally to allowing phase currents of a multiphase switching power supply to be asymmetrically configured to any percentage of the total load current while maintaining excellent dynamic performance. According to certain other aspects, this allows for increased design flexibility for board area, solution cost and optimized efficiency.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 is a block diagram illustrating an example single phase voltage regulator.

FIG. 2 is a schematic diagram illustrating an example multiphase voltage regulator in a master-slave configuration.

FIG. 3 provides waveforms illustrating aspects of how the multiphase voltage regulator in FIG. 2 operates.

FIG. 4 is a block diagram illustrating an example asymmetric multiphase voltage regulator architecture according to the present embodiments.

FIGS. 5A to 5C are schematic diagrams illustrating example implementation details of an asymmetric multiphase voltage regulator architecture such as that shown in FIG. 4 according to the present embodiments.

FIG. 6 provides timing diagrams of example simulated operating results of an asymmetric multiphase voltage regulator according to embodiments.

FIG. 7 is a flowchart illustrating an example asymmetric multiphase voltage regulator methodology according to embodiments.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

The present embodiments relate generally to DC-to-DC voltage conversion, and more particularly to multiphase voltage regulators. One common example of such a voltage regulator, commonly called a buck regulator or buck controller, operates to convert an input voltage (e.g. from an adapter, a power line, battery, etc.) to a lower regulated voltage. It should be noted that although the present embodiments will be described in connection with an example application in a buck regulator, this is not limiting. Rather, one or more principles of the present embodiments can also be practiced in other types of regulators such as buck-boost and boost regulators. According to certain general aspects, the present embodiments more particularly relate to an architecture and methodology that enables individual phase currents of a multiphase voltage regulator to be asymmetrically configured to any percentage of the total load current while maintaining excellent dynamic performance.

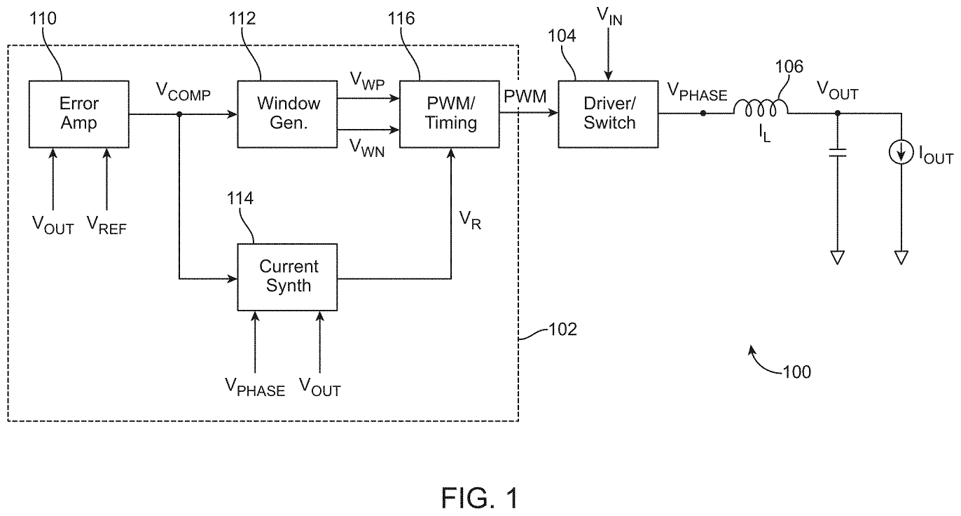

FIG. 1 is a block diagram illustrating an example single phase voltage regulator (VR) 100 for converting an input voltage VIN (e.g. from an adapter) to a regulated output voltage VOUT. In this example, regulator 100 includes a controller 102 and a single power stage 104.

Controller 102 is, for example, a flexible PWM controller. In embodiments, controller 102 can meet any applicable Intel server-class transient performance specifications, any microprocessor, FPGA, or Digital ASIC rail requirements and can include an adjustable load setting. In these and other embodiments, applications of voltage regulator 100 can include networking equipment, telecom and datacom equipment, server and storage equipment, Internet of Things (IOT) devices, point-of-load power supply (e.g., power supply for memory, DSP, ASIC, FPGA cores), etc.

Power stage 104 is a switching power controller component. It receives a PWM signal from controller 102 and drives current from an input power source having voltage V_{IN} into its respective inductor 106 based thereon, as can be done in any number of ways known to those skilled in the art. For example, power stage 104 can include switching transistors such as power MOSFETs, as well as drivers and other similar components.

In the example of FIG. 1, controller 102 is a hysteretic controller. Accordingly, as shown, it includes an error amplifier 110, a window generator 112, a current synthesizer 114, and PWM/timing logic 116.

In general operation, error amplifier 110 receives a feedback signal representing the output voltage V_{OUT} and a reference voltage W_{REF} and generates a compensation signal COMP based on a difference between the two voltages. Window generator 112 receives the COMP signal and generates upper and lower window voltages V_{WP} and V_{WN}, respectively, based thereon (typically fixed voltage values above and below COMP). Current synthesizer 114 receives V_{IN} and V_{PHASE} and uses them to generate an estimate of the current through inductor 106, which current estimate takes the form of a ramp signal V_{R} (i.e. a synthesized current signal). PWM/timing logic 116 compares the ramp signal V_{R} with the upper and lower window voltages V_{WP} and V_{WN} and uses the results of the comparison to develop PWM and/or clock signals for controlling power stage 104. In general, these signals from PWM/timing logic 116 cause power stage 104 to begin to increase the current through inductor 106 when V_{R} reaches V_{WN} and to begin to decrease the current when V_{R} reaches V_{WP}.

According to certain aspects, hysteretic control such as that provided by VR 100 provides higher noise immunity and shaping for transient performance while maintaining current mode control. However, there are many design challenges when attempting to expand the total load current range of a single phase VR (e.g. to account for a wide range of operating and load conditions) without causing very undesirable increases in design cost and consumption of board area. To address these and other challenges, multiphase voltage regulators have been developed.

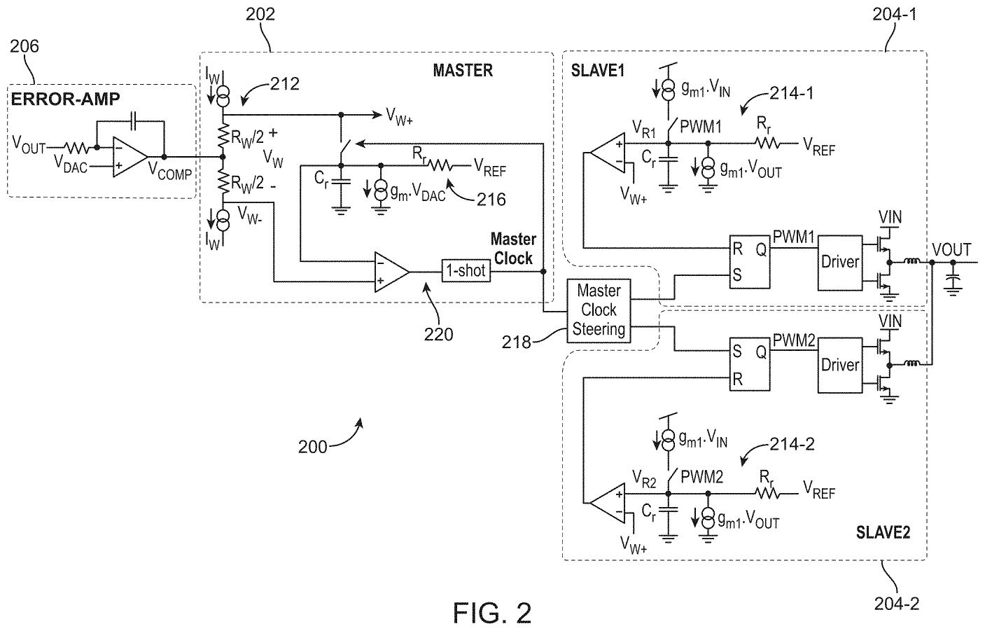

FIG. 2 is a schematic diagram illustrating an example multiphase VR 200 in a master-slave configuration. More particularly, as shown in this example, VR 200 includes master 202 and two slaves or phases 204-1 and 204-2. VR 200 further includes a single error amplifier 206 that implements the error amplifier 110 of FIG. 1 and produces compensation signal COMP based a difference between a signal V_{OUT} representing the output voltage and a reference voltage V_{DAC}. Likewise, master 202 includes a single window generator 212 that implements window generator 112 in FIG. 1 and generates upper and lower window voltages V_{W+} and V_{W-}, respectively.

To implement a master-slave multiphase control scheme, VR 200 includes a number of adaptations to other components of the single-phase VR 100. For example, rather than a single current synthesizer 114, each slave has an inductor current synthesizer 214 which generates its own ramp signal V_{R1}, V_{R2}. As another example, the functionality of PWM/timing block 116 is split between master 202 and slaves 204. More particularly, a dV_{COMP}/dt controlled VCO 216 in master 202 generates a master ramp signal V_{R} which is used to create a master clock (i.e. a clock pulse from a one-shot in block 220 that is fired when a comparator in block 220 detects that the master V_{R} signal falls to the value of the lower window V_{W-}). Based on this master clock, a master clock steering block 218 distributes PWM turn on clocks to each slave phase 204. Each slave turns on PWM in response to the clock from block 218, and turns off PWM when its respective V_{R} reaches a hysteretic window voltage V_{W+} provided by window generator 212 in master 202. This provides peak current mode hysteretic control.

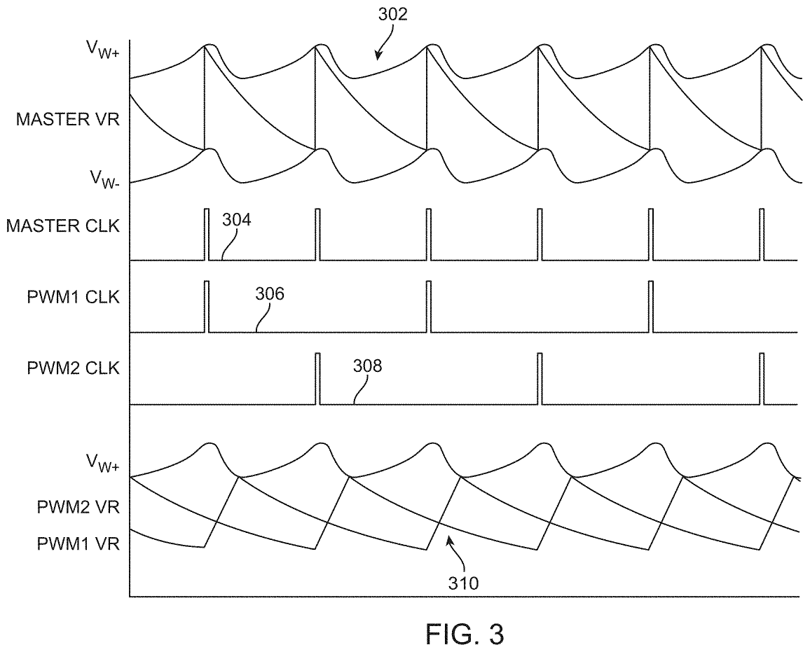

FIG. 3 provides waveforms illustrating aspects of how VR 200 in FIG. 2 operates. As can be seen in this example, waveforms 302 illustrate how the master VR ramp signal from VCO 216 is compared with the upper and lower window voltages V_{W+} and V_{W-} from window generator 212, and waveform 304 illustrates how the master clock is generated based on this comparison (i.e. a clock pulse is generated each time the master VR signal falls to the value of the lower V_{W-} signal).

Waveforms 306 and 308 illustrate the clocks distributed to slaves 204-1 and 204-2 by block 218. As can be seen, block 218 can implement phase interleaving, where each slave receives one-half of the master clocks, in sequential order. It should be noted, however, that VR 1200 can include functionality for adding and dropping phases, depending on load conditions, which can be implemented using various techniques known to those skilled in the art. In this regard, for example, one of slaves 204-1 and 204-2 can be turned off during light load conditions. In this case, in contrast to the waveforms shown in FIG. 3 where both slaves are operating, block 218 can be configured to provide all of the master clocks to the operating one of slaves 204-1 and 204-2.

Finally, referring to FIG. 3, waveforms 310 illustrate the synthesized current or ramp signals generated by each slave 204-1 and 204-2, which are compared to the upper window voltage V_{W+} and used to turn PWM off when the ramp signals reach the upper window voltage.

Multiphase VR's such as those shown in FIG. 2 traditionally attempt to maintain excellent phase current balance (i.e. phases are symmetric). This is generally desirable to prevent one phase from taking excess current and potentially causing damage. In the case of FIG. 2, each slave receives half (or IL/N where N is the number of phases) of the total load current IL when all slaves are operating. Current is dynamically shared between slaves due to each slave comparing against the same control voltage (e.g., V_{W+}). Small inaccuracies can be compensated with a separate current balance loop (not shown).

For current balance, however, each phase generally needs to have the same inductance, and each phase inductance of the multiphase VR can be lower than the inductance in a comparable single phase VR. So when phases are dropped, the amount of inductance in a single operating phase of a multiphase VR is lower and both ripple specification and overall power conversion efficiency is impacted negatively. In particular, the present Applicant recognizes that multiphase VR's generally have poorer light load efficiency than single phase VR's. This can be especially problematic in situations where, for example, the input power source (e.g. the supply for VIN) is a battery. In these situations, prolonged periods of light load conditions can cause a multiphase VR to drain the battery more quickly than a single phase VR, which can undermine the other benefits of using a multiphase VR instead of a single phase VR.

The present embodiments address the above and other problems by allowing for asymmetric inductances and load currents in each phase without impacting overall dynamic performance. Each phase naturally tracks to the desired target. When phases are shed, the remaining active phase(s) will have larger inductors that reduce ripple and maintain higher efficiency.

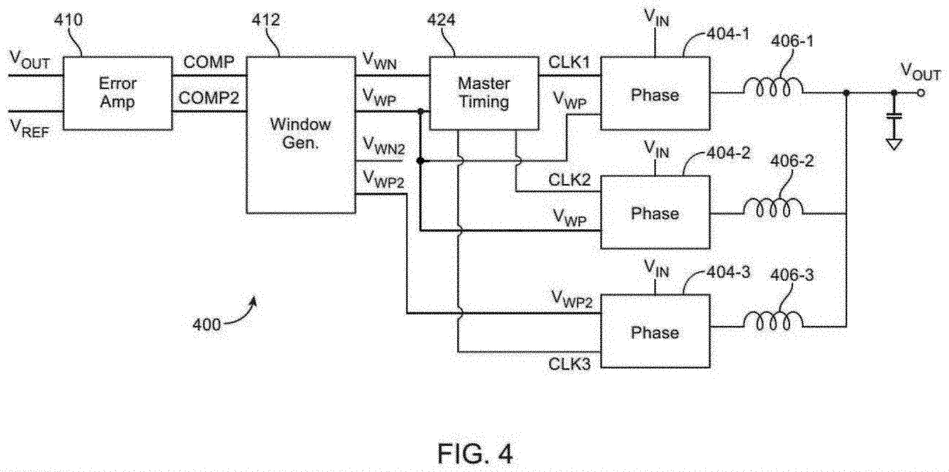

FIG. 4 is a block diagram illustrating an example VR 400 architecture according to the present embodiments.

Rather than phases being symmetric as in the previous examples, they are asymmetric in this VR architecture. Specifically in this three-phase example to be described in more detail below, inductor 406-3 of phase 404-3 is twice the size of the inductors 406-1 and 406-2 of phases 404-1 and 404-2. It should be noted that any numbers of phases and inductor size ratios are possible, and those skilled in the art will be able to implement such other numbers and ratios after being taught by the present examples.

To implement control over this asymmetric architecture, VR 400 includes a number of features. For example, error amplifier 410 generates a secondary compensation signal, COMP2, that has half the gain of the original COMP signal but the same DC operating position.

Window generator 412 generates around COMP2 a new hysteretic window that is half of V_{W}, as represented by outputs V_{WP2} and V_{WP2} in addition to V_{WP} and V_{WN}. The asymmetric phase 404-3 receives the new window voltage V_{WP2}, whereas the other phases receive V_{WP}. Although not shown in FIG. 4, C_{R} is increased in the current synthesizer of asymmetric phase 404-3 by two times to emulate the increased inductor size. The result is a slave that that tracks its inductor current by half of the others. Otherwise, phases 404-1, 404-2 and 404-3 can be implemented similarly as phases 204-1 and 204-2 as described in connection with FIG. 2.

Master timing module 424 can include components similar to those in previous examples for providing clock signals to control the PWM turn on of the phases. It should be noted that master timing module 424 can have functionality for, by itself or by receiving controls from an external source such as an embedded controller, adding and dropping phases. This can be done based on load conditions, and in many ways known to those skilled in the art. In any event, based on the number of phases that are active at a given time, master timing module 424 can adjust the provision of clock signals to only the active phases, and to turn on an off phase interleaving as appropriate. Similarly, individual phases 404 can be turned on and off as appropriate. Preferably, however, the asymmetric phase is always operational (i.e. the last phase to be dropped).

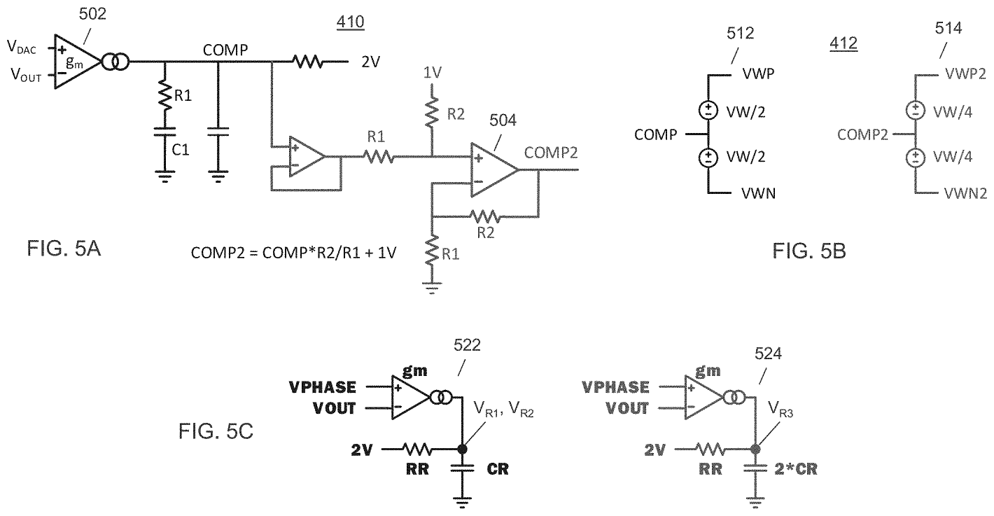

FIGS. 5A to 5C are schematic diagrams illustrating example implementation details of a VR architecture such as that shown in FIG. 4 according to the present embodiments.

More particularly FIG. 5A is a schematic diagram of an example error amplifier 410 according to embodiments. As shown, it includes a gₘ amplifier 502 that generates a first compensation signal COMP based on a difference between a signal representing the output voltage V_{OUT} and a reference V_{DAC}. The signal COMP is provided to an amplifier network including error amplifier 504 that generates a secondary compensation signal COMP2. In this example, the values of resistors R1 and R2 in the amplifier network can be chosen to cause COMP2 to be a predetermined ratio of COMP.

FIG. 5B is a schematic diagram of an example window generator 412 according to embodiments. As shown, window generator 412 includes a first generator 512 that generates upper and lower window voltages V_{WP} and V_{WN} that are positively and negatively offset, respectively, by the same voltage amount V_{W}/2 from COMP. A second generator 514 generates upper and lower window voltages V_{WP2} and V_{WN2} that are positively and negatively offset, respectively, by the same voltage amount V_{W}/4 from COMP2.

FIG. 5C is a schematic diagram of example current synthesizers for phases 404 according to embodiments. As shown in this example, synthesizer 522 generates ramp signals V_{R1} and V_{R2} for phases 404-1 and 404-2 using a gm amplifier that receives V_{PHASE} and V_{OUT} and a capacitance C_{R} that is proportional to the inductance of phases 404-1 and 404-2. As further shown in this example, synthesizer 524 generates ramp signal V_{R3} for asymmetric phase 404-3 using a gm amplifier that receives V_{PHASE} and V_{OUT} and a capacitance 2*C_{R} that is proportional to the increased inductance of phase 404-3. The result is a slave that that tracks its inductor current by half of the others.

It should be noted that the gains of all of the gm amplifiers in these examples are the same.

It should be further noted that, although the example components in FIGS. 5A to 5C depict an example that allows an asymmetric phase to operate at a predetermined fraction that is half the current (and twice the inductance) of one or more other phases, many other ratios, fractions, multiples, percentages, etc. are possible. Moreover, error amplifier 410, window generator 412 and phases 404 can be configured to allow for several different ratios for an asymmetric phase(s) to be selected (e.g. by external control signals from an embedded controller or other configuration circuitry such as pinstraps, etc.). For example, with reference to the example of FIG. 5C, phase 404 can include switches (not shown) to allow for various multiples of C_{R} to be included in the current synthesizer depending on ratio of the attached inductance and desired phase current, and these different capacitances can be switched into the circuit to obtain the desired synthesizer (e.g. 522, 524, etc.) based on control signals or other configurations.

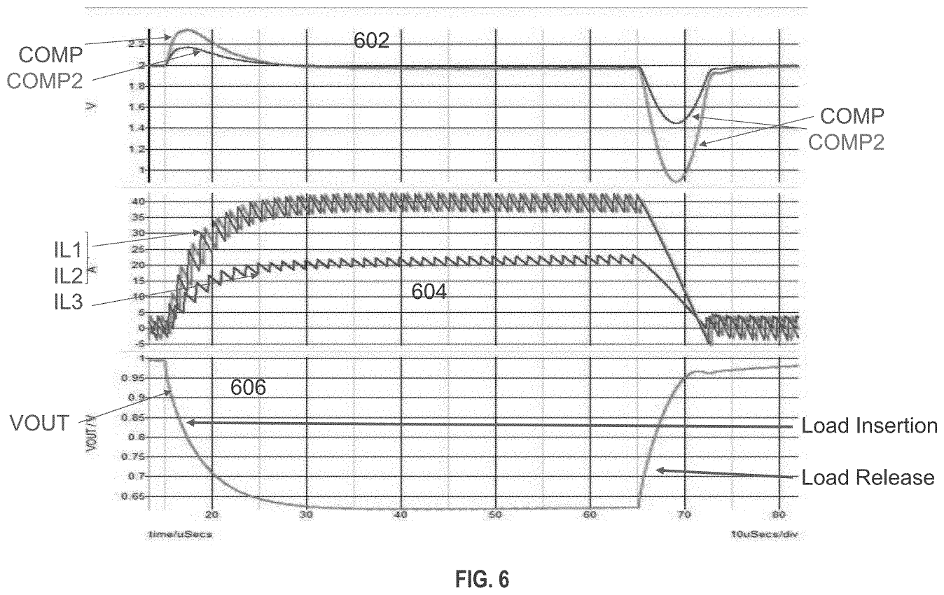

FIG. 6 provides timing diagrams of an example simulation of a VR according to embodiments during a load insertion condition and a load release condition, as represented by the change in VOUT shown in waveform 606.

Waveforms 602 illustrate the response of signals COMP and COMP2 to the conditions, as well as how COMP2 has one-half the gain of COMP while otherwise tracking COMP. Waveforms 604 illustrate how the current IL3 in the asymmetric phase has one half the value of the currents IL1 and IL2 in the symmetric phases, while all phases are being operated.

FIG. 6 further illustrates that there is excellent dynamic performance with the asymmetric inductors and phase currents with a 0A to 100A load step at 100A/us di/dt.

It should be noted that only one three-phase example was shown in this presentation. However, the principles of the embodiments can be easily expanded to other examples. Moreover, different inductors on every phase can be used. Further, the same inductor can be used but with different current scaling. Still further, current scaling that is independent of inductor scaling can be employed. Those skilled in the art will understand how to implement such variations after being taught by these examples.

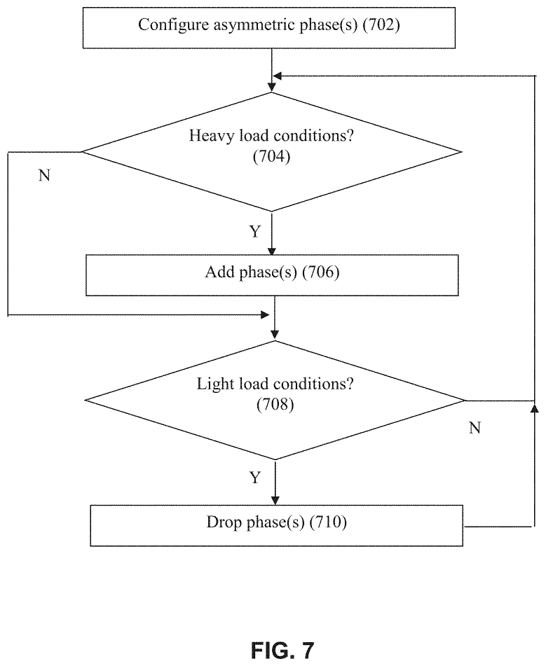

FIG. 7 is a flowchart of an example asymmetric multiphase voltage regulator methodology according to embodiments.

In block 702, the voltage regulator is configured with one or more asymmetric phases. This can be done based on the respective values of inductances 406 included in each phase 404. For example, with reference to the three-phase examples of FIGS. 4 and 5A to 5C, an external entity or other control circuit, with knowledge of the inductance values 406-1 to 406-3, can cause phases 404-1 and 404-2 to implement the current synthesizer 522 and phase 404-3 to implement current synthesizer 524. Similarly, error amplifier 410 can be configured to additionally provide COMP2 that has half the gain as COMP to the window generator 412, and window generator 412 can be configured to provide window voltages to phase 404-3 that are half the window voltages provided to phases 404-1 and 404-2.

In block 704, it can be determined if there are heavy load conditions (or if operating load conditions have changed to be heavier than before). This can be done by monitoring the output current and/or voltage and comparing to a threshold, using various techniques known to those skilled in the art. In this case, or for example when the regulator is first powered up, block 706 is entered, where one or more phases are added. For example, with reference to the three-phase examples of FIGS. 4 and 5A to 5C, an external entity or other control circuit, with knowledge of heavy load conditions, can cause phases 404-1 to 404-3 to all operate, and cause master timing controller 424 to send clock signals to all three phases, with interleaving.

In block 708, it can be determined if there are light load conditions (or if operating load conditions have changed to be lighter than before). This can be done by monitoring the output current and/or voltage and comparing to a threshold, using various techniques known to those skilled in the art. In this case, block 710 is entered, where one or more phases are dropped. For example, with reference to the three-phase examples of FIGS. 4 and 5A to 5C, an external entity or other control circuit, with knowledge of light load conditions, can cause one or both of phases 404-1 and 404-2 to be turned off, and cause master timing controller 424 to send clock signals to only the operating phases, with interleaving if appropriate. It should be noted that, in this example where phase 404-3, and the value of its inductance 406-3 being twice the other inductances, is preferably the last phase to be turned off, so as to achieve improved light load efficiency.

Although the present embodiments have been particularly described with reference to preferred ones thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A multiphase voltage regulator (VR), comprising:
a first phase that is configured to generate a first phase current when the first phase is active; and
a second phase that is configured to generate a second phase current when the second phase is active, the second phase current being a predetermined fraction less than the first phase current.

2. The multiphase VR of claim 1, wherein the first phase comprises a first inductor that has an inductance that is about the predetermined fraction of an inductance of a second inductor of the second phase.

3. The multiphase VR of claim 1, further comprising a window generator that generates first and second window voltages for the first and second phases, respectively, wherein the second window voltage is about the predetermined fraction less than the first window voltage.

4. The multiphase VR of claim 3, wherein the first and second phases include first and second comparators that receive the first and second window voltages, respectively, the first and second comparators controlling first and second PWM on times of the first and second phases, respectively, using the first and second window voltages.

5. The multiphase VR of claim 4, wherein the first and second comparators further receive first and second ramp voltages that are established using first and second capacitors, respectively, wherein the first capacitor has a capacitance that is about the predetermined fraction less than a capacitance of the second capacitor.

6. The multiphase VR of claim 5, wherein the first and second ramp voltages are established using first and second gm amplifiers, respectively, wherein a gm value of the first and second gm amplifiers is about the same.

7. The multiphase VR of claim 3, wherein the window generator generates the first and second window voltage based on an output of an error amplifier that compares an output voltage of the multiphase VR to a reference voltage.

8. The multiphase VR of claim 7, wherein the first and second window voltages have first and second gains from the output of the error amplifier, wherein the second gain is about the predetermined fraction less than the first gain.

9. The multiphase VR of claim 3, further comprising a master timing module that is configured to generate first and second clock signals for the first and second phases, respectively, using the first window voltage.

10. The multiphase VR of claim 1, wherein the predetermined fraction is one-half.

11. A method of operating a multiphase VR, comprising:
configuring a first phase to generate a first phase current when the first phase is active; and
configuring a second phase to generate a second phase current when the second phase is active, the second phase current being a predetermined fraction less than the first phase current.

12. The method of claim 11, wherein configuring the first and second phases includes configuring the first phase with a first inductor that has an inductance that is about the predetermined fraction of an inductance of a second inductor of the second phase.

13. The method of claim 11, further comprising:
generating first and second window voltages for the first and second phases, respectively, wherein the second window voltage is about the predetermined fraction less than the first window voltage.

14. The method of claim 13, wherein the first and second phases include first and second comparators that receive the first and second window voltages, respectively, the method further comprising:
controlling, by the first and second comparators, first and second PWM on times of the first and second phases, respectively, using the first and second window voltages.

15. The method of claim 14, wherein the first and second comparators further receive first and second ramp voltages, the method further comprising:
establishing the first and second ramp voltages using first and second capacitors, respectively, wherein the first capacitor has a capacitance that is about the predetermined fraction less than a capacitance of the second capacitor.

16. The method of claim 15, wherein establishing the first and second ramp voltages further includes using first and second gm amplifiers, respectively, wherein a gm value of the first and second gm amplifiers is about the same.

17. The method of claim 13, wherein the first and second window voltages are generated based on an output of an error amplifier that compares an output voltage of the multiphase VR to a reference voltage.

18. The method of claim 17, wherein the first and second window voltages have first and second gains from the output of the error amplifier, wherein the second gain is about the predetermined fraction less than the first gain.

19. The method of claim 13, further comprising generating first and second clock signals for the first and second phases, respectively, using the first window voltage.

20. The method of claim 11, further comprising:
controlling the first and second phases to be active based on load conditions of the multiphase VR, wherein controlling includes causing only the second phase to be active in a first light load condition, and causing both the first and second phases to be active in a second heavy load condition.
